(19) United States
(12) Patent Application Publication
(10) Pub. No.: US 2014/0320034 A1
(43) Pub. Date: Oct. 30, 2014

(54) Luminaire

(71) Applicant: Toshiba Lighting & Technology Corporation, Yokosuka-shi (JP)

(72) Inventor: Takuro Hiramatsu, Yokosuka-shi (JP)

(73) Assignee: Toshiba Lighting & Technology Corporation, Yokosuka-shi (JP)

(21) Appl. No.: 14/143,041

(22) Filed: Dec. 30, 2013

(30) Foreign Application Priority Data
Apr. 24, 2013 (JP) 2013-091816

(51) Int. Cl. F21V 23/02; H05B 33/08

(52) U.S. Cl. CPC F21V 23/02; H05B 33/0809
USPC 315/201; 362/95; 315/200 R

(57) ABSTRACT

According to an embodiment, there is provided a luminaire including a light-emitting unit and a cap. The luminaire is attached to a socket including first and second sections to be fit. The light-emitting unit includes a first terminal, a second terminal, and a light-emitting element electrically connected between the first terminal and the second terminal. The light-emitting element is lit if a voltage between the first terminal and the second terminal is equal to or larger than a predetermined value. The cap includes first and second fitting sections. The first and second fitting sections are fit in the first and second sections to be fit of the socket to apply a voltage input from the outside between the first terminal and the second terminal. The predetermined value is equal to or larger than 18.7 V and equal to or smaller than 120 V.

### CROSS-REFERENCE TO RELATED APPLICATIONS

This application is based upon and claims the benefit of priority from Japanese Patent Application No. 2013-091816, filed on Apr. 24, 2013; the entire contents of which are incorporated herein by reference.

### FIELD

Embodiments described herein relate generally to a luminaire.

### BACKGROUND

As one of luminaires, there is a low-voltage halogen lamp that is lit with a voltage of about 12 V. The low-voltage halogen lamp is connected to a control device including an electronic transformer. The electronic transformer converts a commercial power supply of AC 100 V into AC 12 V power and supplies the power to the low-voltage halogen lamp.

There is a movement to replace the low-voltage halogen lamp with a luminaire including a light-emitting element such as an LED for the purpose of a reduction in power consumption. In the replacement of the lamp, it is also necessary to replace a control device including an electronic transformer designed for the low-voltage halogen lamp in the past with a device adapted to a light-emitting element. The new control device is a control device not including an electronic transformer. However, a user sometimes forgets the change of the control device or inadvertently connects the lamp including the light-emitting element to the control device in the past. In this case, the operation of the electronic transformer becomes unstable. For example, flickering and noise occur. Therefore, in the luminaire including the lighting-emitting element, it is desired that misconnection to the electronic transformer is suppressed.

### BRIEF DESCRIPTION OF THE DRAWINGS

FIG. 1 is a block diagram schematically showing a luminaire according to a first embodiment;

FIGS. 2A to 2C are schematic diagrams showing the luminaire according to the first embodiment;

FIG. 3 is a block diagram schematically showing a luminaire according to a second embodiment;

FIGS. 4A and 4B are schematic diagrams showing another luminaire according to the second embodiment;

FIGS. 5A and 5B are block diagrams schematically showing a luminaire according to a third embodiment; and

FIGS. 6A and 6B are schematic diagrams showing a luminaire according to a fourth embodiment.

### DETAILED DESCRIPTION

According to an embodiment, there is provided a luminaire including a light-emitting unit and a cap. The luminaire is attached to a socket including first and second sections to be fit. The light-emitting unit includes a first terminal, a second terminal, and a light-emitting element electrically connected between the first terminal and the second terminal. The light-emitting element is lit if a voltage between the first terminal and the second terminal is equal to or larger than a predetermined value. The cap includes first and second fitting sections. The first and second fitting sections are fit in the first and second sections to be fit of the socket to apply a voltage input from the outside between the first terminal and the second terminal. The predetermined value is equal to or larger than 18.7 V and equal to or smaller than 120 V.

Embodiments are explained below with reference to the drawings.

Note that the drawings are schematic or conceptual. Relations between thicknesses and widths of sections, ratios of sizes among the sections, and the like are not always the same as real ones. Even if the same sections are shown, dimensions and ratios of the sections are sometimes shown different depending on the drawings.

Note that, in this specification and the drawings, components same as components already explained with reference to the drawing are denoted by the same reference numerals and signs and detailed explanation of the components is omitted as appropriate.

### First Embodiment

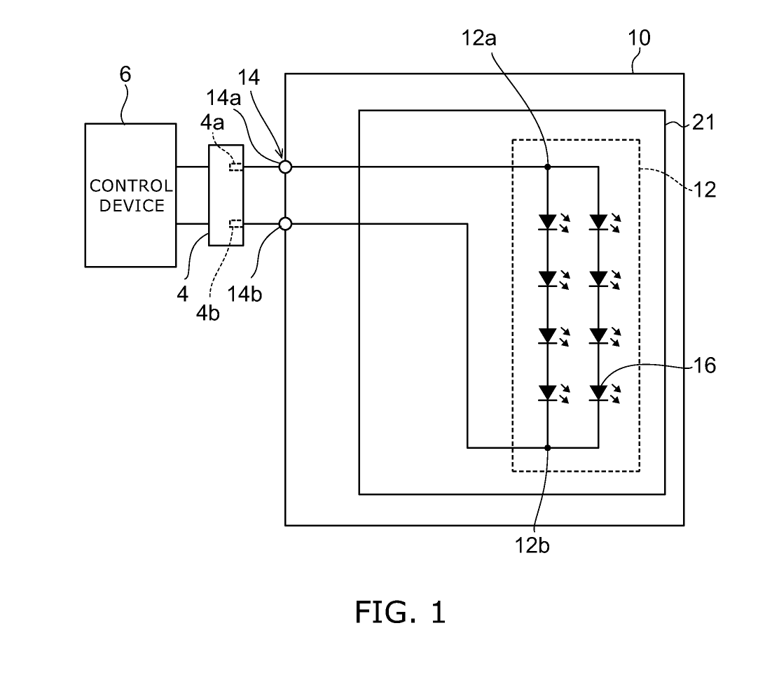

FIG. 1 is a block diagram schematically showing a luminaire according to a first embodiment.

As shown in FIG. 1, a luminaire 10 includes a light-emitting unit 12 and a cap 14. The light-emitting unit 12 includes a first terminal 12a, a second terminal 12b, and a light-emitting element 16. The light-emitting element 16 is electrically connected between the first terminal 12a and the second terminal 12b.

In the light-emitting element 16, a light emitting diode (LED) is used. That is, in this example, the luminaire 10 is an LED lamp. The light-emitting element 16 is not limited to the LED and may be, for example, an organic light emitting diode (OLED) or a laser diode.

In the light-emitting unit 12, for example, a plurality of the light-emitting elements 16 are provided. In this example, eight light-emitting elements 16 are provided. In this example, four light-emitting elements 16 are connected in series. The four light-emitting elements 16 connected in series are connected in parallel. Connection of the light-emitting elements 16 may be arbitrary. For example, the light-emitting elements 16 may be connected in series or may be connected in parallel to one another. The number of the light-emitting elements 16 may be arbitrary. For example, only one light-emitting element 16 may be provided.

For example, among the four light-emitting elements 16 connected in series, an anode of the first light-emitting element 16 is electrically connected to the first terminal 12a. A cathode of the last light-emitting element 16 is electrically connected to the second terminal 12b. Consequently, if an electric current flows in one direction from the first terminal 12a to the second terminal 12b, the light-emitting elements 16 are lit. Note that the first terminal 12a and the second terminal 12b may be arbitrary electric connection points from which an electric current can be fed to the light-emitting elements 16 connected in series or in parallel. For example, among the four light-emitting elements 16 connected in series, the anode of the first light-emitting element 16 may be the first terminal 12a and the cathode of the last light-emitting element 16 may be the second terminal 12b.

The luminaire 10 further includes a substrate 21. The light-emitting elements 16 are provided on the substrate 21. The substrate 21 includes a not-shown wiring pattern. The light-emitting elements 16 are arranged in contact with the wiring pattern to be mounted on the substrate 21.

The cap 14 is electrically connected to the light-emitting unit 12. A pair of pins 14a and 14b (first and second fitting sections) are provided in the cap 14. The sizes such as lengths and diameters of the pair of pins 14a and 14b are substantially the same. For example, the pin 14a is electrically connected to the first terminal 12a and the pin 14b is electrically connected to the second terminal 12b.

The cap 14 is detachably held in a socket 4. The socket 4 includes a pair of holes 4a and 4b (first and second sections to be fit). The pair of pins 14a and 14b are inserted into the holes 4a and 4b, whereby a below-mentioned control device 6 and the luminaire 10 are electrically connected. The sizes such as depths and diameters of the holes 4a and 4b are substantially the same. Therefore, the pins 14a and 14b are reversibly connectable to the holes 4a and 4b. That is, the pin 14a is connectable to one of the holes 4a and 4b. The pin 14b is connectable to the other of the holes 4a and 4b in a state in which the pin 14a is connected. In this way, the luminaire 10 is mechanically held in the socket 4 by the cap 14 and electrically connected to the socket 4 by the cap 14. The cap 14 applies a voltage input from the outside via the socket 4 between the first terminal 12a and the second terminal 12b. Note that the first and second fitting sections and the first and second sections to be fit are not limited to the above-mentioned example. In particular, the first and second fitting sections and the first and second sections to be fit optimally have shapes for making it possible to reversibly connect the first and second fitting sections to the first and second sections to be fit. For example, the first and second sections to be fit may be concave sections.

The socket 4 is electrically connected to the control device 6. That is, the luminaire 10 is electrically connected to the control device 6 via the socket 4. The control device 6 converts, for example, an alternating-current voltage into a direct-current voltage corresponding to the light-emitting elements 16 and supplies the direct-current voltage to the luminaire 10. The control device 6 converts, for example, an alternating-current voltage of 100 V of a commercial power supply into a predetermined direct-current voltage and supplies the direct-current voltage to the luminaire 10. Note that the control device 6 is designed to be suitable for the luminaire in this embodiment and does not include an electronic transformer. In this way, the luminaire 10 is designed mainly as a light source electrically connected to the control device 6, which does not include an electronic transformer and outputs a direct-current voltage, by fitting the cap 14 in the socket 4. In the control device 6, for example, the pin 14b is set to common potential (e.g., ground potential) and the pin 14a is set to potential higher than the common potential. Consequently, a forward voltage is applied to the light-emitting elements 16 and the light-emitting elements 16 are lit.

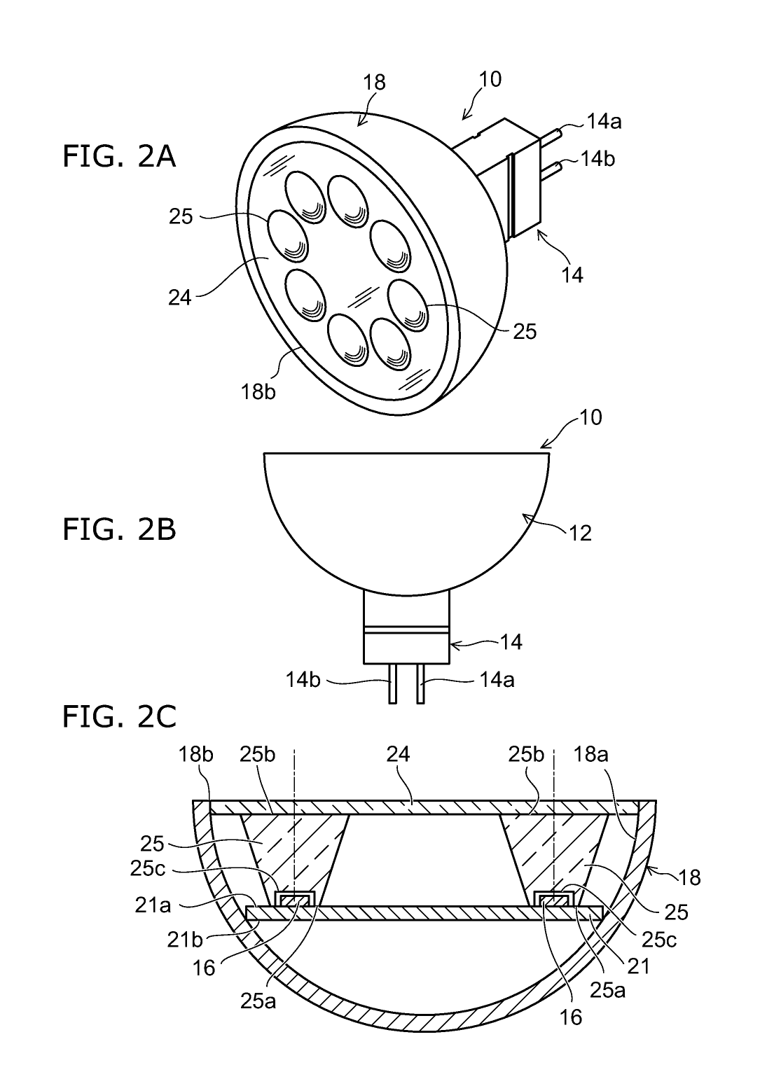

FIGS. 2A to 2C are schematic diagrams showing the luminaire according to the first embodiment.

FIG. 2A is a perspective view schematically showing the luminaire 10. FIG. 2B is a side view schematically showing the luminaire 10. FIG. 2C is a schematic sectional view showing a part of the luminaire 10 in enlargement.

As shown in FIGS. 2A to 2C, the luminaire 10 includes a case 18. FIG. 2C schematically shows a cross section of the case 18. The case 18 is formed in, for example, a bowl shape. The case 18 includes, for example, an inner surface 18a having a rotated paraboloid shape and an opening 18b. In other words, the opening 18b is an opened end of the inner surface 18a. The cap 14 is provided, for example, on the outer surface of the case 18 on the opposite side of the opening 18b.

The substrate 21 is provided on the inside of the case 18. The substrate 21 is formed in, for example, a disc shape. The substrate 21 includes a front surface 21a. The substrate 21 is provided, for example, on the inside of the case 18 with the front surface 21a directed to the opening 18b side. The light-emitting elements 16 are provided on the front surface 21a. For example, the light-emitting elements 16 are arranged in a ring shape on the front surface 21a. The arrangement of the light-emitting elements 16 may be arbitrary.

In the case 18, a cover 24 and a lens 25 are further provided. The cover 24 closes the opening 18b of the case 18. The cover 24 is formed in, for example, a tabular shape. In this example, the cover 24 is formed in a disc shape. The cover 24 has optical transparency to lights emitted from the light-emitting elements 16 (hereinafter referred to as emitted lights). The cover 24 is, for example, transparent. As the cover 24, for example, plastics, glass, or the like is used.

A plurality of the lenses 25 are respectively provided to correspond to the light-emitting elements 16. That is, in this example, eight lenses 25 are provided. The lenses 25 have optical transparency to the emitted lights of the light-emitting elements 16. The lenses 25 are, for example, transparent. As the lenses 25, for example, plastics, glass, or the like is used. The lenses 25 are provided, for example, between the substrate 21 and the cover 24. The lenses 25 may be integrated with, for example, the cover 24.

The lenses 25 include first ends 25a opposed to the light-emitting elements 16 and second ends 25b on the opposite side of the first ends 25a. Each of the lenses 25 is arranged to be opposed to each of the light-emitting elements 16. The emitted light from the light-emitting element 16 is made incident on the first end 25a of the lens 25. The lens 25 emits, for example, the emitted light, which is made incident from the first end 25a, from the second end 25b to thereby control a luminous intensity distribution angle of the emitted light. The lens 25 condenses, for example, the emitted light. The lens 25 sets, for example, the luminous intensity distribution angle of the emitted light to be equal to or smaller than a predetermined value. The lens 25 may be, for example, a lens that diffuses the emitted light.

At the first ends 25a of the lenses 25, concave sections 25c for covering the light-emitting elements 16 are provided. Consequently, for example, it is possible to improve incident efficiency of the emitted light on the lenses 25. More specifically, the first ends 25a are opposed to the light-emitting elements 16 on the inner bottom surfaces of the concave sections 25c. Note that the cover 24 and the lenses 25 are provided according to necessity and can be omitted as appropriate.

The case 18 is, for example, an MR16 type. The cap 14 is, for example, a GU5.3 type. That is, the luminaire 10 is an LED lamp of a so-called low-voltage halogen lamp type. The case 18 may be, for example, an AR111 type. The cap 14 may be, for example, a G53 type. The shape of the case 18 and the shape of the cap 14 may be, for example, arbitrary shapes conforming to the standard of the low-voltage halogen lamp type.

The light-emitting elements 16 are lit if a voltage equal to or larger than a predetermined value is applied between the first terminal 12a and the second terminal 12b. Specifically, a voltage equal to or larger than a forward voltage of the light-emitting elements 16, which are LEDs, is applied between the first terminal 12a and the second terminal 12b, whereby the light-emitting elements 16 are lit. In the luminaire 10, the predetermined value is equal to or larger than 18.7 V and equal to or smaller than 120 V. Therefore, the control device 6 supplies, for example, a direct-current voltage equal to or higher than 18.7 V and equal to or lower than 120 V to the luminaire 10. In this example, the four light-emitting elements 16 are connected in series. In this case, for example, an LED having a forward voltage equal to or higher than 4.675 V and equal to or lower than 30 V is used as the light-emitting element 16. Consequently, the predetermined value can be satisfied.

As explained above, in the luminaire 10, for example, the forward voltage of the light-emitting element 16 and the number of the light-emitting elements 16 connected in series are adjusted. Consequently, a voltage for starting lighting of the light-emitting element 16 can be set to be equal to or higher than 18.7 V and equal to or lower than 120 V. For example, a resistor may be connected between the first terminal 12a and the second terminal 12b to be parallel to the light-emitting element 16. The predetermined value may be satisfied by a division ratio to the resistor.

In the field of lighting, there is a movement to replace a low-voltage halogen lamp or the like with a luminaire including a light-emitting element such as an LED. When the low-voltage halogen lamp is replaced with the luminaire, it is necessary to also replace an electronic transformer for the low-voltage halogen lamp with the control device 6 for the luminaire. For the replacement, a power supply line of an AC 100 V system needs to be reinserted. Therefore, a user not having a qualification such as a registered electrician cannot perform the replacement. Therefore, if an unqualified user desires the replacement, the user needs to request a qualified company to perform the replacement.

When the user requests the company to perform the replacement, the company sometimes inadvertently forgets the replacement of the control device 6 and connects the luminaire in this embodiment to an electronic transformer. The user sometimes inadvertently connects the luminaire to the control device in the past including the electronic transformer. The electronic transformer outputs an alternating-current voltage of about 12 V. Therefore, if a voltage for starting lighting of the light-emitting elements is about 12 V, even if the luminaire is connected to the electronic transformer, the luminaire is lit.

The electronic transformer has a characteristic that the electronic transformer does not stably operate unless a certain degree of an electric current is fed to the electronic transformer. Power consumption of the luminaire including the light-emitting element such as the LED is small compared with power consumption of the low-voltage halogen lamp. The luminaire in this embodiment does not include a circuit such as a power conversion circuit. Therefore, in the luminaire, a necessary electric current sometimes cannot be fed and the operation of the electronic transformer becomes unstable. For example, an output of the electronic transformer becomes intermittent and flickering and noise occur. Therefore, in the luminaire including the light-emitting element, it is desired to suppress misconnection to the electronic transformer.

On the other hand, in the luminaire 10 according to this embodiment, the voltage for starting the lighting of the light-emitting elements 16 is set to be equal to or higher than 18.7 V. An output voltage of the electronic transformer is about 12 Vrms±10%. That is, a peak voltage of an output of the electronic transformer is about 18.7 V. Therefore, if the luminaire 10 according to this embodiment is connected to the control device in the past including the electronic transformer, the light-emitting elements 16 are not lit. Consequently, the user or the like notices the misconnection. It is possible to suppress unstable lighting from being continued. In the luminaire 10 according to this embodiment, the voltage for starting the lighting of the light-emitting elements 16 is equal to or lower than 120 V. Consequently, for example, the standard of IEC60598-1 can be satisfied.

### Second Embodiment

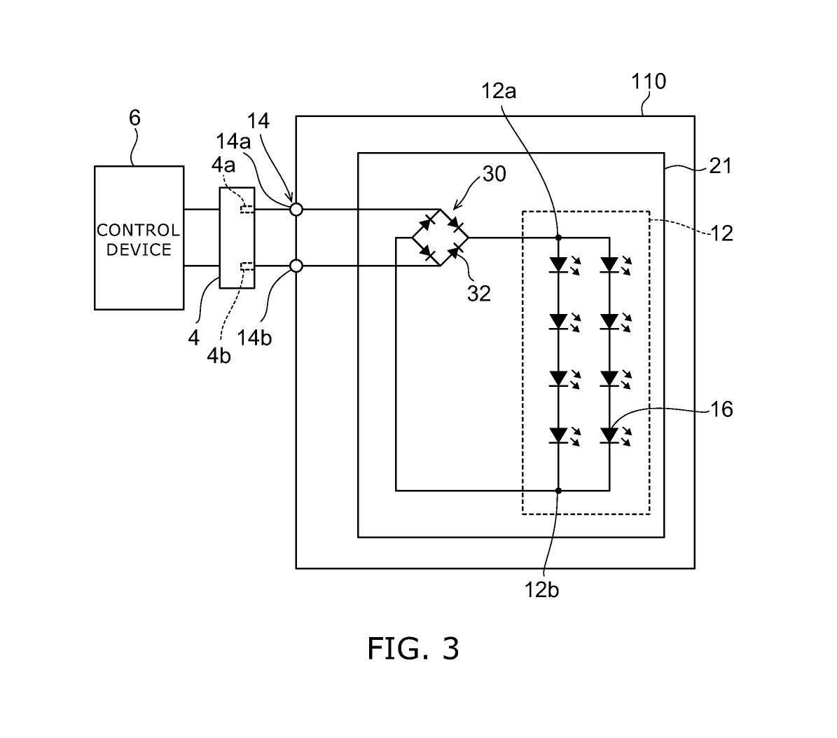

FIG. 3 is a block diagram schematically showing a luminaire according to a second embodiment.

As shown in FIG. 3, a luminaire 110 further includes a rectifier 30. The rectifier 30 is electrically connected between the cap 14 and the light-emitting unit 12. The rectifier 30 rectifies an electric current flowing to the light-emitting unit 12 to one direction from the first terminal 12a to the second terminal 12b. That is, the rectifier 30 rectifies the electric current flowing to the light-emitting unit 12 to a forward direction of the light-emitting elements 16.

The rectifier 30 is, for example, a bridge circuit including four diodes 32. The rectifier 30 is provided, for example, on the substrate 21. As the rectifier 30, for example, a rectifier obtained by housing the four diodes 32 in one package may be used. The rectifier 30 may be formed by mounting the four diodes 32 on the substrate 21. Note that the rectifier 30 is not limited to the bridge circuit including the four diodes 32 and may be an arbitrary circuit that can rectify an electric current flowing to the light-emitting unit 12.

If the rectifier 30 is provided on the substrate 21, it is preferable that the substrate 21 is a double-sided mounting substrate and the rectifier 30 is provided on a rear surface 21b (see FIG. 2C) of the substrate 21. The rear surface 21b is a surface on the opposite side of the front surface 21a. Consequently, it is possible to suppress the rectifier 30 from being seen from the outer side. For example, it is possible to improve a design property of the luminaire 110.

The shapes of the pins 14a and 14b of the cap 14 are substantially the same. Therefore, in the luminaires 10 and 110, when the cap 14 is inserted into the socket 4, it is likely that the directions of the pins 14a and 14b are wrong. In the luminaire 10 in the first embodiment, if the directions of the pins 14a and 14b are wrong, a reverse voltage is applied to the light-emitting elements 16. Therefore, the light-emitting elements 16 are not lit. This also causes a failure of the light-emitting elements 16.

On the other hand, in the luminaire 110 according to this embodiment, even if the cap 14 is inserted into the socket 4 with the pins 14a and 14b set in wrong directions, an electric current can be fed in the direction from the first terminal 12a to the second terminal 12b by the rectifier 30. That is, even if the directions of the pins 14a and 14b are wrong, it is possible to appropriately light the light-emitting elements 16. It is also possible to suppress a failure of the light-emitting elements 16.

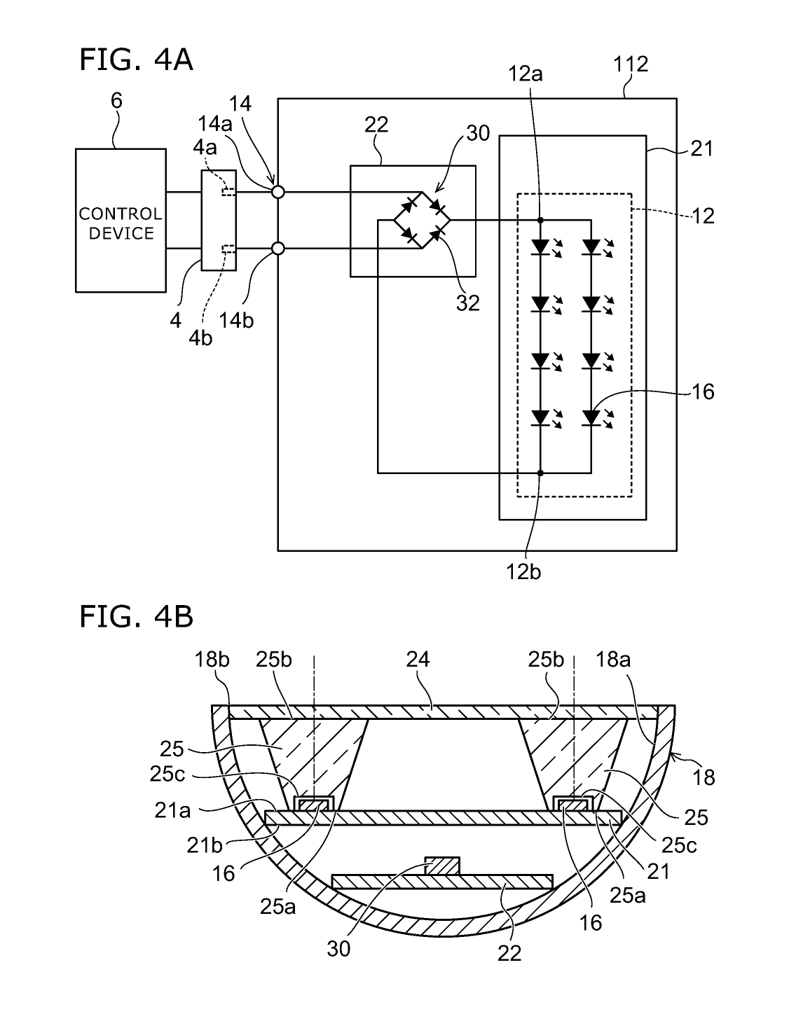

FIGS. 4A and 4B are schematic diagrams showing another luminaire according to the second embodiment.

FIG. 4A is a block diagram schematically showing a luminaire 112. FIG. 4B is a sectional view schematically showing a part of the luminaire 112.

As shown in FIGS. 4A and 4B, the luminaire 112 includes the substrate 21 (a first substrate) on which the light-emitting elements 16 are provided and a substrate 22 (a second substrate) on which the rectifier 30 is provided. In this way, the rectifier 30 may be provided on the substrate 22 separate from the substrate 21 on which the light-emitting elements 16 are provided.

As shown in FIG. 4B, for example, the substrate 22 is arranged to be opposed to the rear surface 21b of the substrate 21. Consequently, it is possible to suppress the rectifier 30 and the substrate 22 from being seen from the outer side. For example, it is possible to improve a design property of the luminaire 112. Note that, in the embodiments, the light-emitting elements 16 are provided on one substrate 21. However, the light-emitting elements 16 may be respectively provided on separate substrates.

### Third Embodiment

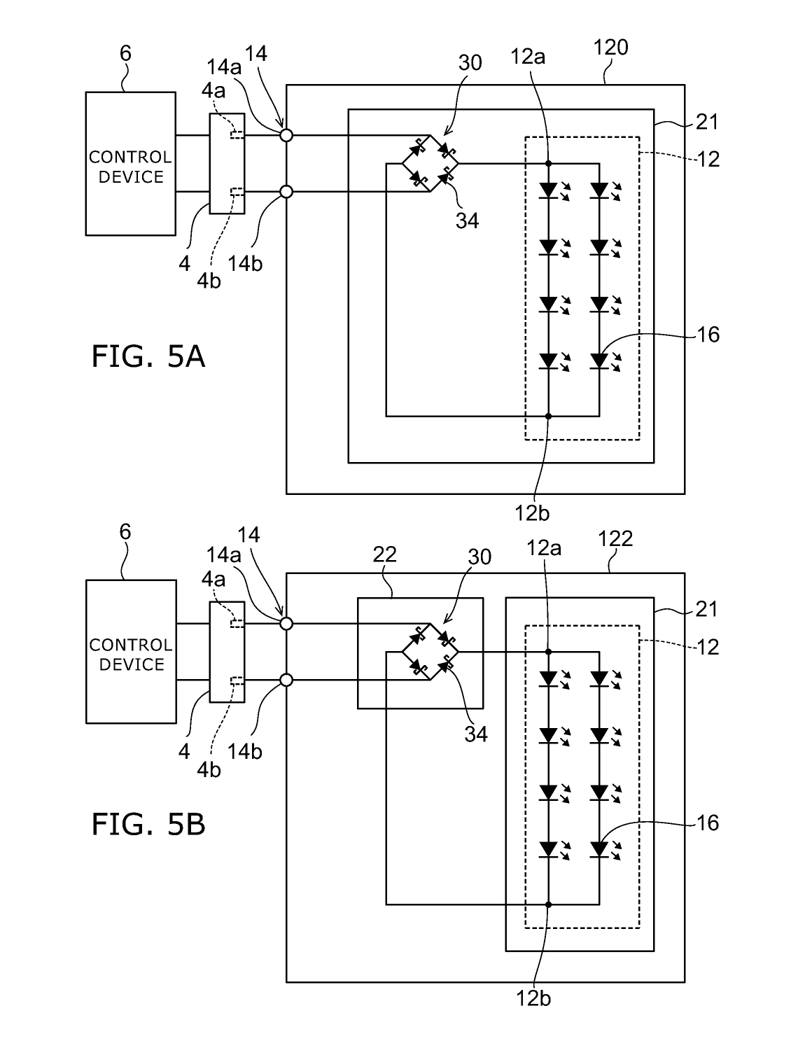

FIGS. 5A and 5B are block diagrams schematically showing a luminaire according to a third embodiment.

As shown in FIG. 5A, in a luminaire 120, the rectifier 30 is a bridge circuit including four Schottky barrier diodes 34.

For example, an alternating-current voltage or a pulsating voltage having a high frequency of about 20 kHz to 100 kHz is supplied from the control device 6 to the luminaire 110 in the second embodiment. In this case, it is likely that the operation of the diode 32 is not in time and an electric current flowing to the light-emitting unit 12 cannot be rectified.

In the Schottky barrier diode 34, for example, compared with a PN junction diode or the like, a voltage fall in the forward direction is low and switching speed is high. Therefore, in the luminaire 120 according to this embodiment, even if an alternating-current voltage or a pulsating voltage having a high frequency is supplied from the control device 6, it is possible to cause the light-emitting elements 16 to appropriately emit light. In this way, the control device 6 may be a control device that supplies the alternating-current voltage or the pulsating voltage to the luminaire including the light-emitting element 16.

In the luminaire 120 shown in FIG. 5A, the rectifier 30 is provided on the substrate 21 same as the substrate 21 on which the light-emitting elements 16 are provided. In a luminaire 122 shown in FIG. 5B, the rectifier 30 is provided on the substrate 22 different from the substrate 21 on which the light-emitting elements 16 are provided. In this way, even if the Schottky barrier diode 34 is used, the rectifier 30 may be provided on the substrate 21 or may be provided on the substrate 22 as in the second embodiment.

### Fourth Embodiment

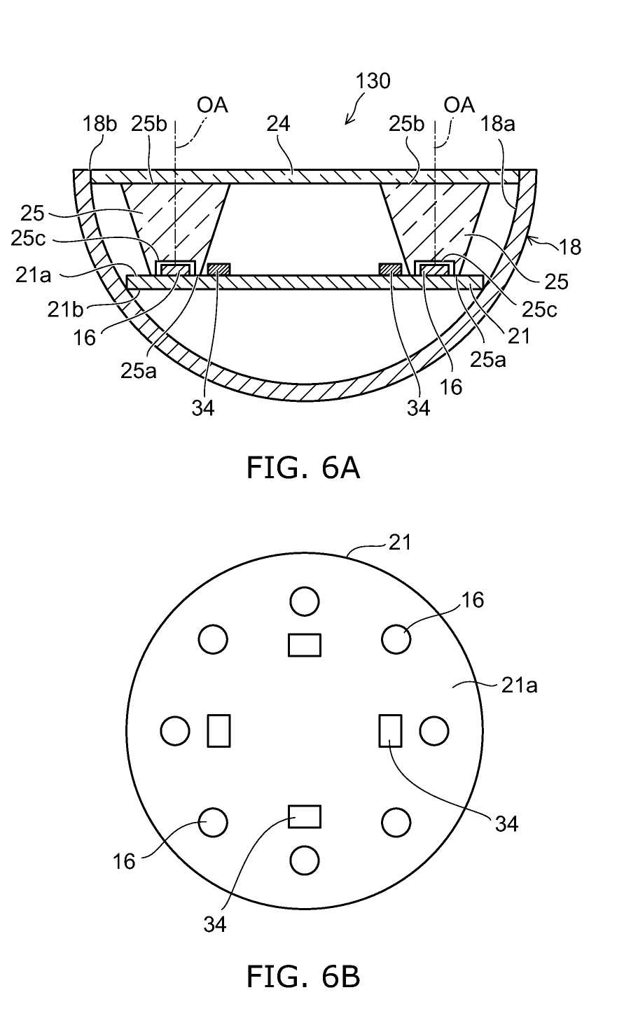

FIGS. 6A and 6B are schematic diagrams showing a luminaire according to a fourth embodiment.

FIG. 6A is a sectional view schematically showing a part of a luminaire 130. FIG. 6B is a plan view schematically showing the substrate 21 of the luminaire 130.

As shown in FIGS. 6A and 6B, in the luminaire 130, the rectifier 30 is provided on the substrate 21 same as the substrate 21 on which the light-emitting elements 16 are provided. The rectifier 30 is provided on the front surface 21a of the substrate 21. That is, in this example, the substrate 21 includes the front surface 21a on which the light-emitting elements 16 and the rectifier 30 are provided. In this example, each of the four Schottky barrier diodes 34 forming the rectifier 30 is provided on the front surface 21a.

The Schottky barrier diodes 34 are arranged in positions not overlapping the first ends 25a of the lenses 25 in a direction perpendicular to the front surface 21a. In other words, the Schottky barrier diodes 34 are arranged in positions not overlapping the first ends 25a of the lenses 25 when viewed in a direction orthogonal to the front surface 21a. That is, the rectifier 30 is arranged in a position not overlapping one ends (the first ends 25a) of the lenses 25 opposed to the light-emitting element 16 in a direction perpendicular to the front surface 21a. Consequently, in an extinguished state or the like, it is possible to suppress the rectifier 30 from being seen from the outer side. For example, it is possible to prevent the Schottky barrier diodes 34 from being easily seen. Consequently, for example, it is possible to improve a design property of the luminaire 130.

The lenses 25 have optical axes OA. The optical axes OA are present, for example, in a direction from the first ends 25a to the second ends 25b. In this example, the direction of the optical axes OA is substantially the same as the direction perpendicular to the front surface 21a. In the lenses 25, the width of the second ends 25b is larger than the width of the first ends 25a. “Width” is the length in a direction perpendicular to the optical axes OA. In other words, “width” is length in a direction parallel to the front surface 21a. The width of the lenses 25 increases, for example, in a direction from the first end 25a to the second end 25b. That is, the width of the lenses 25 increases in a direction in which emitted light is irradiated.

The Schottky barrier diodes 34 are arranged in positions not overlapping the first ends 25a of the lenses 25 and at least partially overlapping the second ends 25b in the direction perpendicular to the front surface 21a. Each of the four Schottky barrier diodes 34 overlaps the second end 25b of any one of the plurality of lenses 25 in the perpendicular direction. That is, at least a part of the Schottky barrier diode 34 is covered with the lens 25 in the direction perpendicular to the front surface 21a. Consequently, it is possible to prevent the Schottky barrier diodes 34 from being easily seen from the outer side.

If the rectifier 30 is arranged as in the luminaire 130, for example, compared with the luminaire in which the substrates 21 and 22 are provided, it is possible to facilitate assembly. Compared with the luminaire in which the substrate 22 is separately provided, for example, it is possible to suppress an increase in costs. In the luminaire 130, for example, it is possible to improve a design property while suppressing an increase in costs.

In the example of the luminaire 130 explained above, the Schottky barrier diodes 34 are arranged on the front surface 21a. However, for example, the diodes 32 may be arranged as explained above. A device obtained by housing bridge circuits in one package may be arranged as explained above.

In the embodiments, the LED is used as the light-emitting element 16. The light-emitting element 16 is not limited to the LED. An arbitrary light-emitting element that is lit by being applied with a voltage equal to or larger than a predetermined value can be used. For example, an arbitrary light-emitting element having a forward voltage can be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A luminaire comprising:
a light-emitting unit including a first terminal, a second terminal, and a light-emitting element electrically connected between the first terminal and the second terminal, the light-emitting element being lit if a voltage between the first terminal and the second terminal is equal to or larger than a predetermined value; and
a cap attached to a socket including first and second sections to be fit, the cap including first and second fitting sections, and the first and second fitting sections being fit in the first and second sections to be fit of the socket to apply a voltage input from an outside between the first terminal and the second terminal,
the predetermined value being equal to or larger than 18.7 V and equal to or smaller than 120 V.

2. The luminaire according to claim 1, wherein the luminaire does not include a power conversion circuit.

3. The luminaire according to claim 1, wherein the cap is fit in the socket to thereby be electrically connected to a control device not including an electronic transformer and configured to output a direct-current voltage.

4. The luminaire according to claim 1, further comprising a rectifier electrically connected between the cap and the light-emitting unit, wherein
the first and second fitting sections are reversibly connectable to the first and second sections to be fit of the socket,
the light-emitting element is lit when an electric current flows in one direction from the first terminal to the second terminal, and
the rectifier rectifies an electric current flowing to the light-emitting unit to the one direction.

5. The luminaire according to claim 4, wherein the rectifier is a bridge circuit including four diodes.

6. The luminaire according to claim 4, wherein the rectifier is a bridge circuit including four Schottky barrier diodes.

7. The luminaire according to claim 4, further comprising a substrate on which the light-emitting element and the rectifier are provided.

8. The luminaire according to claim 7, wherein
the substrate includes a front surface and a rear surface on an opposite side of the front surface,
the light-emitting element is provided on the front surface, and
the rectifier is provided on the rear surface.

9. The luminaire according to claim 4, further comprising:
a first substrate on which the light-emitting element is provided; and
a second substrate on which the rectifier is provided.

10. The luminaire according to claim 9, wherein
the first substrate includes a front surface and a rear surface on an opposite side of the front surface,
the light-emitting element is provided on the front surface, and
the second substrate is arranged to be opposed to the rear surface.

11. The luminaire according to claim 4, further comprising:
a substrate including a front surface on which the light-emitting element and the rectifier are provided; and
a lens including one end opposed to the light-emitting element, wherein
the rectifier is arranged in a position not overlapping the one end in a perpendicular direction perpendicular to the front surface.

12. The luminaire according to claim 11, wherein
a width of an other end of the lens is larger than a width of the one end, and
at least a part of the rectifier overlaps the other end of the lens in the perpendicular direction.

13. The luminaire according to claim 11, wherein
a plurality of the light-emitting elements are provided,
a plurality of the lenses are provided to respectively correspond to the plurality of light-emitting elements,
the rectifier is a bridge circuit including four diodes, and
each of the four diodes does not overlap each of the one ends of the plurality of lenses in the perpendicular direction.

14. The luminaire according to claim 13, wherein
in each of the plurality of lenses, a width of an other end on an opposite side of the one end is larger than a width of the one end, and
each of the four diodes overlaps the other end of any one of the plurality of lenses in the perpendicular direction.

15. The luminaire according to claim 13, wherein the four diodes are Schottky barrier diodes.

16. The luminaire according to claim 13, wherein the plurality of light-emitting elements are arranged in a ring shape on the front surface.

17. The luminaire according to claim 7, further comprising a case including an opening, wherein
the substrate is provided on an inside of the case.

18. The luminaire according to claim 17, further comprising a cover having optical transparency and configured to close the opening of the case.

19. The luminaire according to claim 1, wherein
the first and second sections to be fit are a pair of holes, and
the first and second fitting sections are a pair of pins.

20. The luminaire according to claim 1, wherein the light-emitting element is a light-emitting diode.
